(19) United States
(12) Patent Application Publication
(10) Pub. No.: US 2023/0116211 A1
(43) Pub. Date: Apr. 13, 2023

(54) DENTAL MILLING MACHINE FOR THE PRODUCTION OF A DENTAL OBJECT

(71) Applicant: Ivoclar Vivadent AG, Schaan (LI)

(72) Inventors: Dario TOMMASINI, Zizers (CH); Jonas REINHARDT, Igis (CH); Göpf ROHNER, Altstätten (CH); Martin HUBER, Pfarrwerfen (CH)

(21) Appl. No.: 17/938,522

(22) Filed: Oct. 6, 2022

(30) Foreign Application Priority Data
Oct. 7, 2021 (EP) 21201453

(51) Int. Cl. A61C 13/00; A61C 3/02

(52) U.S. Cl. CPC A61C 13/0006; A61C 13/0022; A61C 3/02; G05B 2219/45167

(57) ABSTRACT

A dental milling machine (100) for manufacturing a dental object (101), having a microphone (103) for detecting sound signals during a milling operation or an accelerometer for detecting vibration signals; and a position determining device (105) for determining a position of a milling tool (107) and/or a workpiece (111) based on the sound signals or the vibration signals.

### CROSS-REFERENCE TO RELATED APPLICATIONS

This application claims priority to European patent application No. 21201453.4 filed on Oct. 7, 2021, which disclosure is incorporated herein by reference in its entirety.

### TECHNICAL FIELD

The present invention relates to a dental milling machine for manufacturing a dental object, and a dental milling method for manufacturing a dental object.

### BACKGROUND

In dental milling machines, there is currently no possibility to automatically measure the accuracy of the manufactured indications or positions of the holders and blanks. For this purpose, a reference body is milled, which is then measured by the customer using an outside micrometer. This result is manually calculated in the machine control and the zero point of the machine is corrected. A user can therefore calibrate or check the dental milling machine simply by milling and measuring a test specimen. In this procedure, the sum of all errors and the errors of the measuring tool (measurement) are recorded. In addition, various measuring devices (3D probe, laser, IBS, measuring head) are used to measure and correct the mechanical alignment.

This results in additional costs and space requirements. The position determination is sensitive to external influences, such as the presence of cooling water, and work is required to check the accuracy of the external test equipment. In addition, measurement errors occur if the measurement is not permanently integrated in the dental milling machine. These arise because an additional tool, such as a probe, is clamped in place. A milling tool-to-workpiece calibration is performed again for each new milling tool-to-workpiece combination because of the production tolerances of the workpiece.

US 20190324116 and 20190192256 are directed to milling methods and are hereby incorporated by reference in their entirety. US 20160175976 and 20130163382 are directed to methods of detecting a position of a device and are hereby incorporated by reference in their entirety.

### SUMMARY

It is the technical aim of the present invention to enable an accurate position detection of a milling tool with respect to the clamped workpiece to be milled within a dental milling machine.

This technical aim is achieved by objects according to the independent claims. Technically advantageous embodiments are the subject of the dependent claims, the description and the drawings.

According to a first aspect, the technical task is solved by a dental milling machine for manufacturing a dental object, comprising a microphone for detecting sound signals during a milling operation or an accelerometer for detecting vibration signals; and an electronic position determining device for determining a position of a milling tool and/or a workpiece based on the sound signals and/or the vibration signals. If the position, length and/or dimensions of the milling tool are known, the position of the workpiece may be determined based on the sound signals or vibration signals. The position of the workpiece may be determined in the coordinate system of the milling tool. An accelerometer can be a structure-borne sound sensor or every other sensor that is capable for detecting vibrations and generating vibration signals.

If the position and/or dimensions of the workpiece are known, the position of the milling tool can be determined based on the sound signals or vibration signals. The position of the milling tool can be determined in the coordinate system of the workpiece.

This provides, for example, the technical advantage that a position of the milling tool can be determined with little effort. The sound signals or vibration signals can also be used for adaptive control, process monitoring or process control during the milling process. The microphone or the accelerometer serves as a measuring means for determining the position of the milling tool.

In a technically advantageous embodiment of the dental milling machine, the microphone or the accelerometer is arranged in a milling head of the dental milling machine. This achieves, for example, the technical advantage that the sound signals or vibration signals can be well detected during machining of the workpiece.

In a further technically advantageous embodiment of the dental milling machine, the position determination device is designed to transform the sound signal or the vibrations signal into the frequency domain. First, the sound signal is detected by the microphone in the time domain and then transformed into the frequency domain by means of a Fourier transformation. Also, the vibration signal is detected by the accelerometer in the time domain and then transformed into the frequency domain by means of a Fourier transformation. This achieves, for example, the technical advantage that the sound signal generated during processing can be easily separated from other sound signals.

In a further technically advantageous embodiment of the dental milling machine, the dental milling machine comprises a plurality of microphones for detecting sound signals during a milling process or a plurality of accelerometers for detecting vibration signals. This achieves, for example, the technical advantage that the position of the milling tool can be determined more precisely.

In a further technically advantageous embodiment of the dental milling machine, the microphone is designed to detect sound signals with a frequency between 5 kHz and 20 kHz or the accelerometer is adapted to detect vibration signals having a frequency between 1 Hz and 1 MHz. This achieves, for example, the technical advantage that particularly suitable frequency ranges are used to detect the sound signals or vibration signals and interference influences are reduced.

In a further technically advantageous embodiment of the dental milling machine, the position determining device is configured to determine a phase shift between a first and a second sound signal or a phase shift between a first vibration signal and a second vibration signal. This achieves, for example, the technical advantage that the position of the milling tool can be determined precisely.

In a further technically advantageous embodiment of the dental milling machine, the position determining device is configured to detect a contact of the milling tool on the workpiece. This achieves, for example, the technical advantage that a relative relationship can be established between the milling tool and the workpiece.

In a further technically advantageous embodiment of the dental milling machine, the position determining device is configured to detect a spatial shape of a workpiece. This achieves, for example, the technical advantage that the dimensions and geometry of the workpiece can be determined in a simple manner.

In a further technically advantageous embodiment of the dental milling machine, the milling process is controlled on the basis of the sound signals or vibration signals. This achieves, for example, the technical advantage that overheating or sticking of the milling tool can be prevented.

According to a second aspect, the technical problem is solved by a dental milling method for producing a dental object, comprising the steps of detecting sound signals during a milling operation with a microphone or detecting vibration signals during a milling process with an accelerometer; and determining a position of a milling tool and/or a workpiece based on the sound signals or the vibration signals. Thereby, the same technical advantages as provided by the dental milling machine according to the first aspect are achieved.

In a technically advantageous embodiment of the dental milling process, the sound signal or the vibration signal is transformed into the frequency domain. This also achieves, for example, the technical advantage that the sound signal or vibration signal generated during processing can be easily separated from other sound signals or vibration signals.

In a further technically advantageous embodiment of the dental milling process, the sound signals are detected at a frequency between 5 kHz and 20 kHz or the vibration signals are detected at a frequency between 1 Hz and 1 MHz. This also achieves, for example, the technical advantage that particularly suitable frequency ranges are used for detecting the sound signals.

In a further technically advantageous embodiment of the dental milling method, a phase shift between a first sound signal and a second sound signal is determined or a phase shift between a first vibration signal and a second vibration signal is determined. The first sound signal may have been detected by a first microphone and the second sound signal may have been detected by a second microphone. The first vibration signal can be detected by a first accelerometer and the second vibration signal can be detected by a second accelerometer This also provides, for example, the technical advantage that the position of the milling tool can be detected more accurately.

In a further technically advantageous embodiment of the dental milling process, a contact of the milling tool with the workpiece is detected. In this case, the milling tool is in a machining mode. This also achieves, for example, the technical advantage that machining of the workpiece can be carried out more accurately.

In a further technically advantageous embodiment of the dental milling process, the spatial shape of a workpiece is detected.

This also achieves, for example, the technical advantage that the dimensions and geometry of the workpiece can be determined in a simple manner.

### BRIEF DESCRIPTION OF THE DRAWINGS

Examples of embodiments of the invention are shown in the drawings and will be described in more detail below.

FIG. 1 shows a perspective view of a milling head;

FIG. 2 shows a schematic view of a dental milling machine with a position determining device;

FIG. 3 shows sound signals at different states of the dental milling machine;

FIG. 4 shows a microphone with recorded sound signals or a accelerometer with recorded vibration signals; and

FIG. 5 shows a block diagram of a dental milling method for producing a dental object.

### DETAILED DESCRIPTION

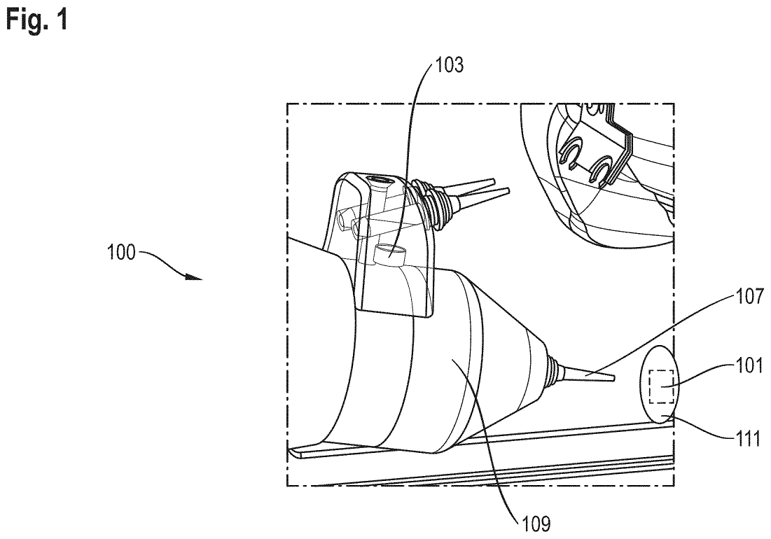

FIG. 1 shows a perspective view of a milling head 109 of a dental milling machine 100. The dental machine 100 is used to produce a dental object 101 using a milling process.

The dental object 101 is, for example, a crown, an abutment, a bridge, a veneer, an inlay, an onlay, or a topping. The dental milling machine 100 mills the dental object 101 from a workpiece using a movable milling tool 107. The milling tool 107 thereby chips or grinds the workpiece 111 until the desired shape of the dental object 101 is achieved. The workpiece 111 is formed by, for example, a ceramic, a glass-ceramic, a composite material, or a metal in the form of a blank. The blank may be in the form of a block, a cuboid, or a disc.

In order to position the milling tool 107 relative to the workpiece 111, a microphone 103 is used as a sensor in the dental milling machine 100 to detect contact of the workpiece 111 with the milling tool 107.

The sound signals detected by the microphone 103 can be used to determine whether the rotating milling tool 107 or the rotating blank is in contact with the workpiece. This enables accurate position determination with space-saving and low technical effort. The dental milling machine can therefore make a reference of the machine accuracy to the measurement of the dental object 101 without manual intervention.

For example, the microphone 103 is a regular acoustic microphone and is configured to detect sound at frequencies between 5 kHz and 20 kHz.

Also, an accelerometer can be used to as a sensor in the dental milling machine 100 to detect contact of the workpiece 111 with the milling tool 107. The accelerometer detects vibration signals. The vibration signals detected by the accelerometer can also be used to determine whether the rotating milling tool 107 or the rotating blank is in contact with the workpiece.

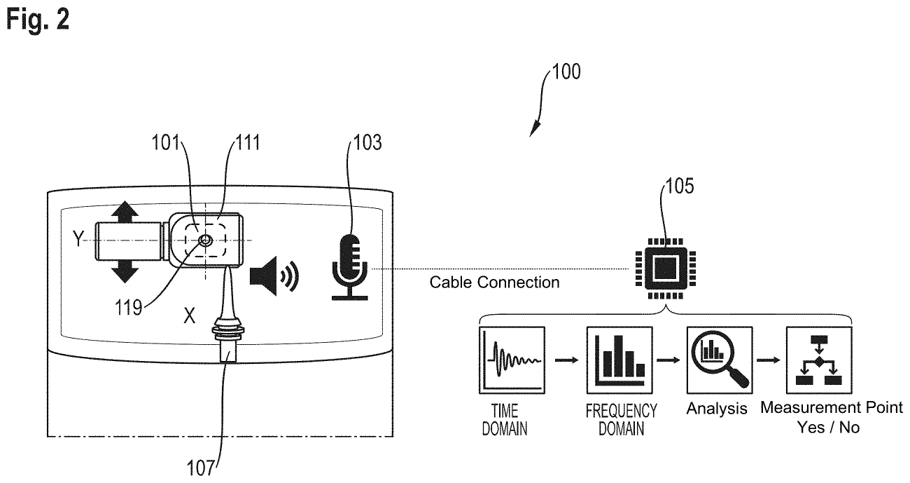

FIG. 2 shows a schematic view of a dental milling machine 100 having a position determining device 105. In the dental milling machine 100, the workpiece 111 having a hole 119 is clamped. The dental object 101 is milled out of the workpiece 111.

For example, the position determining device 105 includes a processor and a digital memory in which programs and data may be stored, such as a RAM memory. The detected sound signals or vibration signals may be stored in the digital memory as data and processed by the processor.

The electronic position determining device 105 acquires the sound signals recorded by the microphone 103 or vibration signals recorded by the accelerometer as digital values. The position determining device 105 also accesses the machine controller and can match the XYZ data with the sound signal or vibration signal. Thus, in a second way, the relative exact position from the workpiece 111 to the milling tool 107 or vice versa is obtained.

This allows the sound or vibrations to be recorded over the course of time. The digital values can be stored in the electronic memory (RAM memory) of the position determining device 105. The position determining device 105 is able to evaluate the recorded sound signals or vibration signals and calculate therefrom a determination of a position of the milling tool. Advantageously, the measurement point is no further away than the average tool length.

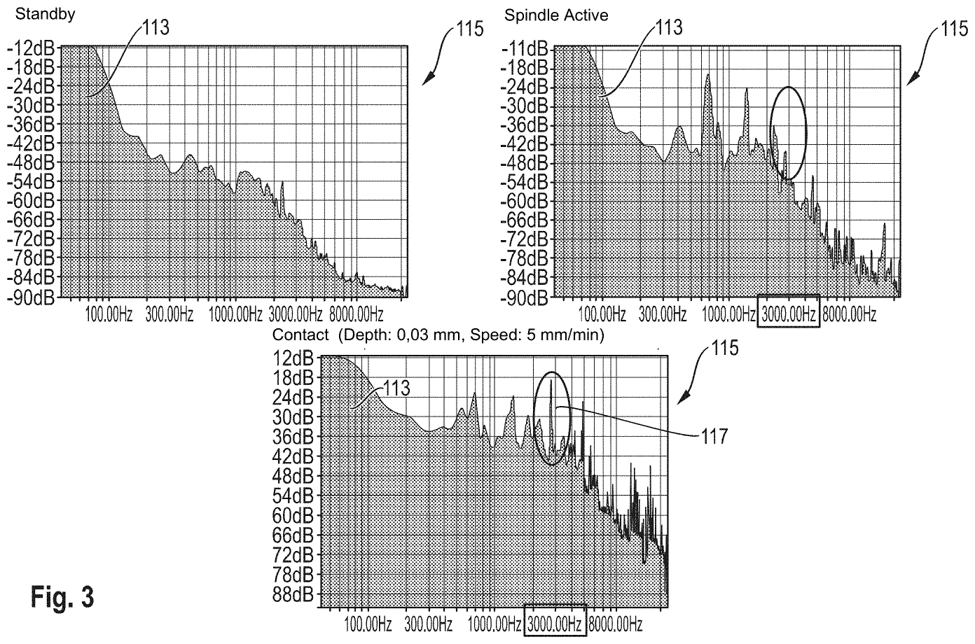

FIG. 3 shows sound signals or vibration signals at different states of the dental milling machine 100. For example, the position of the milling tool 107 can be detected by the sound signals or vibration signals when the milling tool 107 contacts the workpiece 111. The rotating milling tool 107 produces a characteristic noise or vibrations when in contact with the workpiece 111. From this characteristic noise or vibrations, the contact of the milling tool 107 with the workpiece can be detected. For this purpose, a data analysis of the sound signal or vibration signals 113 is performed. In addition, the milling method can be controlled based on the sound signals.

First, sound signals or vibration signals 113 are detected by the position determining device 105 when the milling tool 107 is in operation but not in mechanical contact with the workpiece 111. These sound signals or vibration signals 113 are transformed into the frequency domain using a Fourier transform, such as a Fast Fourier Transform (FFT) algorithm. This results in a frequency spectrum 115 for the condition where the rotating milling tool 107 is not in contact with the workpiece 111. This process is repeated continuously so that frequency spectra 115 are obtained continuously.

When the advance or feed of the dental milling machine 100 is activated, the milling tool 107 moves toward the workpiece 111. Once the milling tool 107 contacts the workpiece 111, the sound signals or vibration signals 113 change as a drilling noise is produced when the workpiece is contacted.

In this case, a peak 117 occurs in the frequency spectrum 115 due to the drilling noise or vibrations. The peak 117 can be easily detected by subtracting frequency spectra 115 detected in succession in time from each other. If the length of the milling tool 107 and the dimensions of the workpiece 111 are known, the position of the milling tool 107 in the reference coordinate system of the workpiece fixture can be determined. Once the peak 117 is detected in the frequency spectrum 115, the coordinate is stored as a contact point by the position determining device 105. This may be the coordinate in the coordinate system of the milling tool 107 or the coordinate in the coordinate system of the workpiece 111. In this way, the contact point can be used to determine the relative position of the milling tool 107 and the workpiece 111. By probing with sound or vibrations, the position and location of the clamped workpiece 111 and/or milling tool 107 can be determined.

The position of the peak 117 in the frequency spectrum 115 depends, among other things, on the speed of the milling tool. At higher speeds, the peak 117 shifts to higher frequencies. At lower speeds, the peak 117 shifts to lower frequencies.

However, the position of the milling tool 107 may be determined in other ways. Operating sounds or vibrations are generated during operation of the milling tool 107. The operating sounds or vibrations are continuously detected by a plurality of microphones 103 or accelerometers 103 of the dental milling machine 100, each of which is arranged at a different position.

Three or four microphones or accelerometers 103 may be used for this purpose. From the different travel times and phase shifts of the operating sounds or the vibrations to the respective microphones or accelerometers 103, the position determining device 105 can calculate the position of the milling tool 107 in space, such as with an acoustic triangulation method. One of the microphones or accelerometers 103 may be located close to the sound source, while the remaining microphones 103 are located at different positions within dental milling machine 100.

In all methods, noise in the sound signals or vibration signals 113 can be removed from the sound signals or vibration signals using suitable digital or electronic filters, such as in a range from 2.5 kHz to 17 kHz. For example, a frequency filter may be used to remove certain frequencies of a soundscape or vibrations that originate from adjacent devices.

The two methods can also be used simultaneously in combination. The methods provide permanent signal monitoring of the sound signals or vibration signals, for example in real time. This means that the position can be detected in the range of a few milliseconds.

For example, if the milling tool 107 is moved at a feed rate of 5 ram/min during position detection, a response time of 10 ms results in a position detection accuracy of 0.8 μm. A response time of 70 ms results in a position detection accuracy of 6 μm.

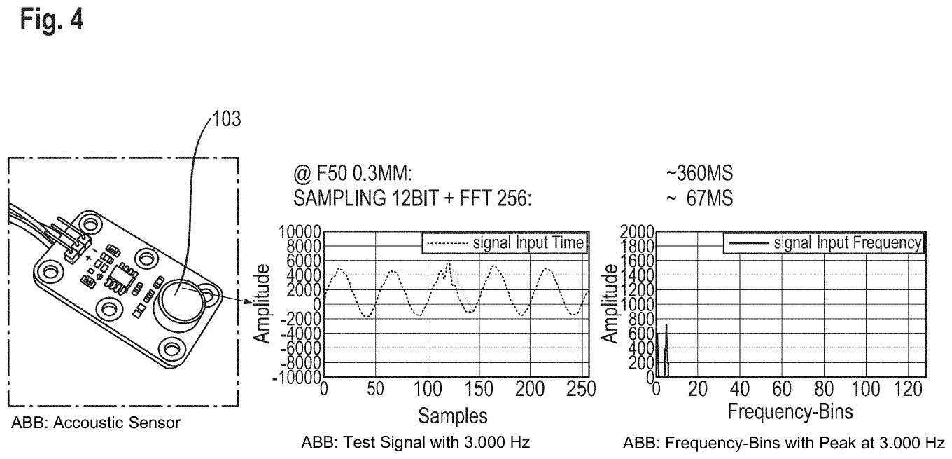

FIG. 4 shows a microphone 103 with recorded sound signals. The microphone 103 may be a regular microphone for capturing sound signals in a range between 100 Hz and 20 KHz. The microphone 103 may be arranged on a rotary spindle or a block holder of the dental milling machine 100 to detect a contact of the milling tool 107.

In another embodiment one or more accelerators can be used for recording vibration signals. Three accelerometers can be arranged such that vibration signals in each direction can be recorded, i.e. X-, Y-, and Z-direction. The accelerometers can be implemented for example on a rotary spindle or a block holder of the dental milling machine 100 to detect a contact of the milling tool 107.

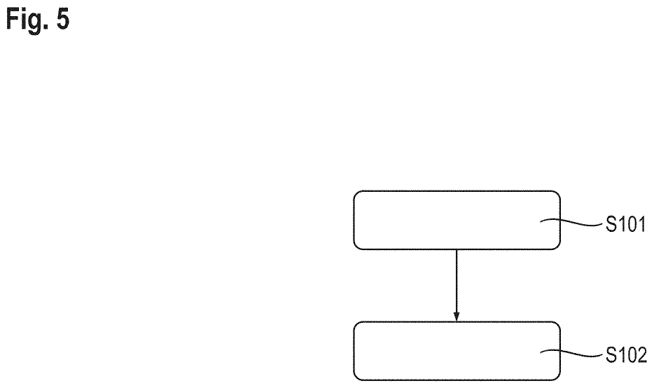

FIG. 5 shows a block diagram of a dental milling methods for manufacturing a dental object 101. The dental milling method comprises the step S101 of detecting sound signals during a milling operation with the microphone 103 or detecting vibration signals during a milling process with an accelerometer, and the step S102 of determining S102 a position of a milling tool 107 based on the sound signals or vibration signals.

By the method, a measurement of any milled shape of the workpiece 111 can be performed during the milling method and immediately before or after machining while the milled workpiece 111 is still clamped in the dental milling machine 100.

The measurement may be used, for example, to align a workpiece 111 having a hole 119 at a predetermined position. When milling the workpiece 111 with the hole 119, the position of the hole 119 relative to the milling tool 107 can be determined to within micrometers. To do this, a workpiece 111 having known dimensions is first clamped into the dental milling machine 100.

Then, the milling tool 107 is approached to the workpiece 111 from different sides, and the position of a contact of the milling tool 107 with the workpiece 111 is determined. For example, in the case of a cuboid block as the workpiece 111, the position of a contact of the milling tool 107 is determined on four different sides such as top, bottom, right and left.

From these positions, the coordinates of the contact point can be determined, such as X, Y and Z coordinates. From these coordinates, the dimensions of the workpiece 111 and the position of the axis system relative to the workpiece 111 can be determined by difference formation. The material of the workpiece 111 remains largely intact during the position detection on the side. If the position of the hole 119 in the workpiece is known, this position can also be calculated from the determined coordinates of the contact points.

If the position of the milling tool 107 is known, the position and/or dimensions of the workpiece 111 may be determined based on the acoustic signals or vibration signals. Conversely, if the position and/or dimensions of the workpiece 111 are known, the position of the milling tool 107 may be determined based on the acoustic signals or vibration signals.

If the position of a hole 119 or a recess in relation to the sides is known, this can be calculated from the previously determined positions of the sides. In this case, the technical advantage is achieved that a tolerance of the clamping system and the workpiece can be compensated for and the milling tool 107 can machine the workpiece so that milling is performed exactly around the hole 119.

One or more microphones or accelerometers 103 in the dental milling machine 100 can also detect when the block comes into contact with the milling tool 107. In this case, a characteristic sound or vibration is emitted, which is measured by the microphone or the accelerometer 103. This noise or vibration can be recorded from multiple sides, so that the position from the block to the workpiece 111 can be measured.

The dental milling method can be implemented with little technical effort and can be retrofitted by installing microphones or accelerometers at a later date. This can also be used for adaptive control, process monitoring or process control during the milling process.

All of the features explained and shown in connection with individual embodiments of the invention may be provided in different combinations in the subject matter of the invention to simultaneously realize their beneficial effects.

All method steps can be implemented by means suitable for executing the respective method step. All functions that are executed by objective features can be a method step of a method.

The scope of protection of the present invention is given by the claims and is not limited by the features explained in the description or shown in the figures.

### REFERENCE LIST

100 Dental milling machine
101 Dental object
103 Microphone/Accelerometer
105 Position determining device
107 Milling tool
109 Milling head
111 Workpiece
113 Sound signal/Vibration signal
115 Frequency spectrum
117 Peak
119 Hole

1. A dental milling machine (100) for producing a dental object (101), comprising
a microphone (103) for detecting sound signals during a milling operation or an accelerometer for detecting vibration signals; and
an electronic position determining device (105) for determining a position of a milling tool (107) and/or a workpiece (111) on the basis of the sound signals and/or the vibration signals.

2. The dental milling machine (100) according to claim 1,
wherein the microphone (103) or the accelerometer is arranged in a milling head (109) of the dental milling machine (100).

3. The dental milling machine (100) according to claim 1,
wherein the position determining device (105) is adapted to transform the sound signals or the vibration signals into the frequency domain.

4. The dental milling machine (100) according to claim 1,
wherein the dental milling machine (100) comprises a plurality of microphones (103) for detecting the sound signals during a milling operation and/or a plurality of accelerometers for detecting the vibration signals.

5. The dental milling machine (100) according to claim 1,
wherein the microphone (103) is adapted to detect the sound signals having a frequency between 5 kHz and 20 kHz or the accelerometer is adapted to detect the vibration signals having a frequency between 1 Hz and 1 MHz.

6. The dental milling machine (100) according to claim 1,
wherein the sound signals comprise a first sound signal and a second sound signal and the vibration signals comprise a first vibration signal and a second vibration signal, and
wherein the position determining device (105) is adapted to determine a phase shift between the first sound signal and the second sound signal or a phase shift between the first vibration signal and the second vibration signal.

7. The dental milling machine (100) according to claim 1,
wherein the position determining device (105) is adapted to detect a contacting contact of the milling tool (107) on the workpiece (111).

8. The dental milling machine (100) according to claim 1,
wherein the position determining device (105) is adapted to detect a spatial shape of a workpiece (111).

9. The dental milling machine (100) according to claim 1,
wherein the milling process is controlled on a basis of the sound signals or vibration signals.

10. A dental milling method for manufacturing a dental object comprising
detecting (S101) sound signals during a milling operation with a microphone (103) or detecting vibration signals during a milling process with an accelerometer; and
determining (S102) a position of a milling tool (107) and/or a workpiece (111) based on the sound signals or vibration signals.

11. The dental milling method according to claim 10,
wherein the sound signals or the vibration signals are transformed into a frequency domain.

12. The dental milling method according to claim 10,
wherein sound signals are detected at a frequency between 5 kHz and 20 kHz or the vibration signals are detected at a frequency between 1 Hz and 1 MHz.

13. The dental milling method according to claim 10,
wherein the sound signals comprise a first sound signal and a second sound signal and the vibration signals comprise a first vibration signal and a second vibration signal, and
wherein a phase shift between the first sound signal and the second sound signal is determined or a phase shift between the first vibration signal and the second vibration signal is determined.

14. The dental milling method according to claim 10,
wherein a contact of the milling tool (107) on the workpiece (111) is detected.

15. The dental milling method according to claim 10,
wherein spatial shape of a workpiece (111) is detected.
